(19) United States
(12) Patent Application Publication
(10) Pub. No.: US 2025/0199935 A1
(43) Pub. Date: Jun. 19, 2025

(54) INCIDENT DRIVEN WORKLOAD DRIFT DETECTION AND CLASSIFICATION

(71) Applicant: Hewlett Packard Enterprise Development LP, Spring, TX (US)

(72) Inventor: Naveena Kedlaya, Bangalore (IN)

(21) Appl. No.: 18/591,128

(22) Filed: Feb. 29, 2024

(30) Foreign Application Priority Data
Dec. 15, 2023 (IN) 202341088021

(51) Int. Cl. G06F 11/34; G06F 11/30; H04L 41/12

(52) U.S. Cl. CPC G06F 11/3414; G06F 11/3006; H04L 41/12

(57) ABSTRACT

In certain embodiments, a computer-implemented method includes: discovering, by a drift detection device executing on one or more processors, a mesh of nodes topology; generating a plurality of subgraphs using the mesh of nodes topology, wherein each of the plurality of subgraphs comprises a portion of a plurality of nodes of the mesh of nodes; selecting a subgraph of the plurality of subgraphs; calculating a Drift-subgraph (D_{sg}) value for the subgraph using a plurality of subgraph incident parameter values; and calculating a drift value (D) using the D_{sg} value and an Incident likelihood (I_{L}) value, wherein the drift value indicates whether drift occurred in the subgraph.

### BACKGROUND

Various types of computing resources are often interconnected with one another. Such computing resources are often used to perform various tasks, process data, etc. From time to time, resource usage patterns may change. It may be challenging to determine the cause of such changes in resource usage patterns.

### BRIEF DESCRIPTION OF THE DRAWINGS

Certain embodiments discussed herein will be described with reference to the accompanying drawings listed below. However, the accompanying drawings illustrate only certain aspects or implementations of embodiments described herein by way of example, and are not meant to limit the scope of the claims.

FIG. 1 illustrates a block diagram of an example system for performing incident driven drift detection in accordance with one or more embodiments of this disclosure;

FIG. 2 illustrates a block diagram of a mesh of nodes, represented as a set of subgraphs in accordance with one or more embodiments disclosed herein;

FIG. 3 illustrates an overview of an example method for performing incident driven drift detection in accordance with one or more embodiments disclosed herein;

FIG. 4 illustrates an example representation of data that may be used to calculate drift, in accordance with one or more embodiments disclosed herein;

FIG. 5 illustrates a block diagram of a computing device, in accordance with one or more embodiments disclosed herein.

### DETAILED DESCRIPTION OF ILLUSTRATIVE EMBODIMENTS

The term “drift” is often used in statistics to describe unforeseen changes in the properties of a target variable(s) over time. In the context of workload deployments, drift may refer to a shift in resource usage patterns of a workload. Such a change in resource usage patterns (e.g., drift) may occur for a variety of reasons, including, but not limited to, expected events, such as startup of services, the execution of periodic tasks (e.g., cron jobs), and/or gradual growth of an application. Other examples of events that may cause unexpected changes in resource usage patterns (e.g., drift) include, but are not limited to, sudden failures of underlying infrastructure components (e.g., when a storage device goes offline and all the load is redirected to a redundant device), faulty firmware, software errors, flaws, bugs, etc. Detecting the causes of drift may be challenging when multiple infrastructure components are involved, making it difficult to identify issues or anticipate component failures. As a result, poorly performing workloads may negatively impact other applications, causing them to operate below expected service level agreement (SLA) compliance levels.

Certain examples of attempts to discover whether drift is occurring (e.g., workload resource usage patterns are unexpectedly changing) may perform simple calculations. As an example, it may be possible to graph network throughput over time for one or more ports, devices, etc., and visually examine the graph to determine if the throughput changed (e.g., became higher or lower) beyond a certain threshold (e.g., twenty percent) and remained so changed for a threshold period of time (e.g., three consecutive five minute windows). However, such calculations only account for two parameters, the measured resource metric (e.g., throughput) and time. Accordingly, such a calculation may omit or fail to comprehend other important parameters that may cause changes in resource consumption, such as application lifecycle events, temporary restarts, periodically run jobs/tasks, device failures, loss of redundancy, etc., which may be referred to herein as incidents. Omitting such incidents when evaluating drift may, as an example, cause the flagging of false positives that are not actual examples of drift that is due to incidents in the mesh that are unintended and cause unexpected drift, not correctly correlating incidents with detected drift, etc.

Embodiments disclosed herein address at least some of the aforementioned problems with drift detection by allowing for detecting drift in an infrastructure of compute resources in which workloads execute, and to help explain the causes of changes in resource usage patterns, which is referred to herein as drift. Techniques disclosed herein may allow for differentiation between genuine incidents, organic growth within the application, and unintended drift occurrences. In one or more embodiments, a value for drift is determined by first creating a mesh representation of a topology of physical and/or logical nodes, representing the mesh as any number of subgraphs, each including a portion of the nodes of the mesh, and then using a variety of incident parameters for a given subgraph to determine a value for drift due to incidents in the subgraph. That value is used, along with an empirically known incident probability value to calculate a drift value, which may indicate whether drift has occurred (e.g., based on whether the drift value is a non-zero, positive number) and the severity of the drift (e.g., based on how high the positive drift value is).

Often, a workload, executing using compute resources, undergoes three distinct states: a warm-up period, followed by a stabilized period, and eventually a termination. The stabilized period represents the duration during which the actual resource usage takes place. In some workloads, resource usage may follow repetitive patterns, which may be referred to as the workload exhibiting periodicity. However, when a drift occurs that deviates from such established patterns, the drift may lead to unintended consequences. For example, one workload may excessively consume resources, depriving other workloads of the necessary resource allocation, thereby triggering a chain of undesirable outcomes.

One or more embodiments disclosed herein establish a logical mesh that includes a predetermined set of nodes. In one or more embodiments, each node within the mesh represents a physical device and/or a logical device. Examples of such devices include, but are not limited to, a compute unit, a storage component, a network element, a storage logical volume, a virtual machine, a container, a pod, a microservice, an application, etc. Other devices may be nodes in a mesh topology without departing from the scope of embodiments disclosed herein.

In one or more embodiments, a mesh is a representation of nodes in a topology (e.g., a network topology). A mesh of nodes may represent a physical topology, a logical topology, or a hybrid mesh that includes aspects of physical and logical topologies. Examples of topologies include, but are not limited to, point-to-point, star, bus, tree, ring, full or partial meshes, layer 2 (L2) network topologies, layer 3 (L3) network topologies, data flow topologies, etc.

In one or more embodiments, drift detection is performed to determine whether unexpected drift is occurring within a mesh of nodes, or any portion thereof (e.g., the nodes in a subgraph), as discussed above. In one or more embodiments, unexpected drift is a significant change in resource usage (e.g., processor usage, network traffic, memory usage, executing threads, etc.) in a short period of time, in comparison to normal resource consumption that occurs in an interconnected topology of physical and/or logical nodes (e.g., the aforementioned mesh). In one or more embodiments, drift may be caused by one or more incidents. In one or more embodiments, an incident is any occurrence in a mesh that may cause drift, such as, for example, device restarts, firmware/software changes, loss of redundancy, increased receipt of network traffic from outside the mesh or subgraph, etc.

Given the potentially large quantity of nodes in modern data centers, embodiments disclosed herein may use node aggregation to form groups, or graphs, where each graph represents a collection of logical and/or physical elements within the mesh of nodes topology. Such an approach allows for an organized representation of and management of a complex network of nodes that may be present in a data center environment. Such graphs may each be a sub-section of the mesh, and referred to herein as a subgraph. In one or more embodiments, representing a mesh of nodes by a number of subgraphs may allow for incidents causing drift in a mesh of nodes to be identified more quickly, as the subgraphs may be separately considered when performing drift calculations (discussed further below).

In one or more embodiments, to obtain a set of subgraphs, the mesh of nodes must first be discovered. Any suitable one or more techniques for identifying nodes and connections between the nodes may be used to discover the mesh. Such techniques include, but are not limited to, network scanners, discovery protocols (e.g., link layer discovery protocol (LLDP)), application protocols (e.g., simple network management protocol (SNMP), web-services management (WS-MAN), etc.), manual configuration and/or discovery, etc.

In one or more embodiments, once the topology of a mesh of nodes is discovered using one or any combination of the various techniques discussed above, or any other suitable techniques, a set of subgraphs may be derived. In one or more embodiments, deriving the subgraphs includes selecting a node as a non-leaf node, and performing a tree traversal within the mesh to a certain depth. Any depth may be chosen for a subgraph without departing from embodiments disclosed herein. As an example, a network device of the overall mesh may be selected as a non-leaf node at which to start a subgraph, and devices connected to the network device may be considered leaf nodes that are at a depth of one, and devices connected to those devices may be at a depth of two relative to the network device, and so on. Any number of tree traversals starting with any number of selected non-leaf nodes and using any pre-selected depth(s) may be used to generate any number of subgraphs without departing from the scope of embodiments disclosed herein. Subgraphs may be non-overlapping (e.g., any given node is in only one subgraph) or partially overlapping (e.g., some nodes may be in more than one subgraph). The selection of how to choose nodes as non-leaf nodes, the depth of tree traversals, the number of subgraphs, etc. may depend on the size and/or complexity of the overall mesh, or any other relevant factor.

In one or more embodiments, once a set of subgraphs of the mesh are obtained, drift may be calculated for any particular subgraph. In one or more embodiments, drift is calculated using the following equation: D=D_{sg}×I_{L}. In one or more embodiments, D is the value for drift in a subgraph in a mesh of nodes, D_{sg} is a value calculated for one or more drifts caused by one or more incidents in a given subgraph, and I_{L} is the likelihood that an incident causes drift.

I_{L} may be derived based on empirical knowledge of incident types. Thus, in one or more embodiments, different incident types may be assigned different values for I_{L} to represent the relative severity of drift due to that incident type. For example, a periodically performed task that happens every week but causes changes in resource usage in an expected manner may be assigned a low value for I_{L} (e.g., one), while a more severe event, such as a sudden and unexpected loss of network redundancy, may be assigned a higher value for I_{L} (e.g., 72). Any type of incident that may cause a change in resource usage in a mesh of nodes may be empirically assigned such a value, and the set of values may be stored in any form of data structure that can relate one type of information (e.g., a type of incident) to another type of information (e.g., an assigned value).

As an example, there may be a table that includes a column for incident types and a corresponding column for assigned values of I_{L}. Expected and/or less severe events may be assigned lower I_{L} values, such as periodic performance of certain services, planned reboots of devices, planned software or firmware updates, application lifecycle events, etc. Unexpected and/or more severe events may be assigned higher I_{L} values, such as loss of redundancy, unexpected reboots, power loss events, firmware crashes, etc.

D_{sg} may be calculated using a second equation: D_{sg}=(Incident Quantity)×(Incident Fraction Potentially Causing Drift)×(Number of Nodes Capable of Causing Incident)×(Node Fraction Capable of Causing an Incident)×(Incident Time).

In one or more embodiments, Incident Quantity is the total number of incidents that occur in a certain window of time for nodes in a selected subgraph. In one or more embodiments, the time window may be selected based on observing resource usage of any one or more types over time for nodes in a subgraph, and the Incident Quantity may be the number of incidents of any type that occur within the time window. As an example, a thirty minute window of time may be observed, and fourteen incidents may occur within the window, making the Incident Quantity value (14).

In one or more embodiments, Incident Fraction Potentially Causing Drift is a selection from the total number of incidents in the Incident Quantity of a subset of the incidents that are known to cause drift. As an example, a systems administrator or network administrator investigating drift in a mesh of nodes may examine the list of incidents that occurred in the time window (e.g., the incidents in the Incident Quantity), and use pre-existing knowledge of incidents to determine that only two of them are the type of incident that could potentially cause relevant drift, making the value for Incident Fraction Potentially Causing Drift ( 2/14).

In one or more embodiments, Number of Nodes Capable of Causing Incident is the number of nodes in a particular subgraph known to be capable of causing any of the incidents used in the Incident Fraction Potentially Causing Drift variable. As an example, an interested entity investigating drift in a mesh of nodes may be aware that only one node in a subgraph that includes five nodes may be a node that could cause the two incidents of the fourteen total incidents, making the value for Number of Nodes Capable of Causing Drift (1).

In one or more embodiments, the Node Fraction Capable of Causing an Incident is a fraction of the number of nodes that could cause an incident divided by the number of nodes in the subgraph. As an example, if a decision is made, as above, that one node in a mesh of five nodes may cause the two incidents known to potentially cause drift (e.g., the incidents used to find the Incident Fraction Potentially Causing Drift), the value for Node Fraction Capable of Causing an Incident is (⅕).

In one or more embodiments, the Incident Time is a length of time for a window in which an incident continues to exist. The Incident Time may be selected based on any relevant decision making parameter. In one or more embodiments, the Incident Time is selected based on domain knowledge or empirical knowledge, and represents a time below which the occurrence of an incident is not significant enough to cause relevant drift. As an example, the Incident time may be selected as thirty minutes, making the value for Incident Time (30).

In one or more embodiments, once D_{sg} is obtained using the aforementioned subgraph incident parameter values, the Drift, D, may be obtained by multiplying D_{sg} by I_{L}. In one or more embodiments, any value of D that is a positive number indicates that an incident occurred that caused drift, with higher values of D indicating more severe drift.

Certain embodiments of this disclosure may allow an entity investigating potential drift occurring in a mesh of nodes to calculate a value for the drift that, if positive, confirms that drift is occurring, with the severity of the drift becoming more evident based on how high the positive value of the calculated drift is. The drift may be correlated to incidents occurring on nodes within a subgraph that are used to derive the parameters used to calculate the drift.

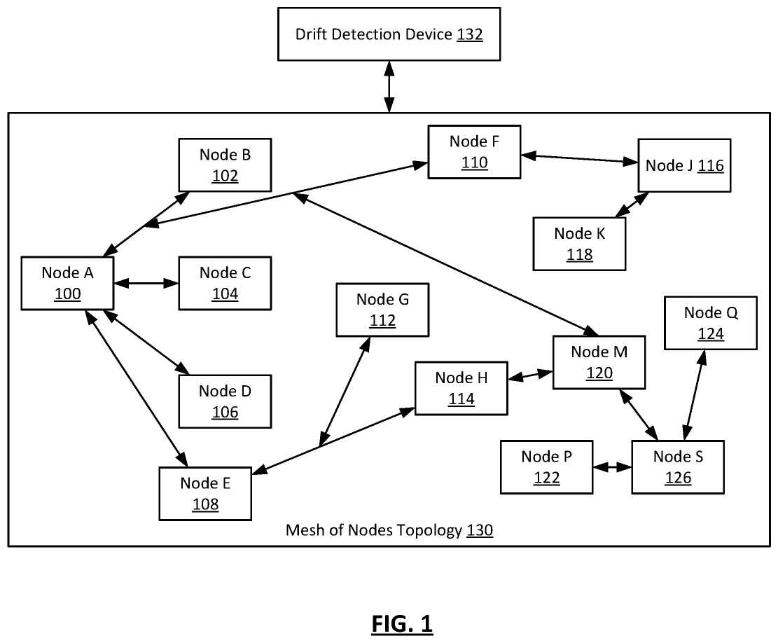

FIG. 1 illustrates a block diagram of an example system for performing incident driven drift detection in accordance with one or more embodiments of this disclosure. As shown in FIG. 1, the system includes a drift detection device 132 and a mesh of nodes topology 130. The mesh of nodes topology 130 may include any number of nodes, such as for example, node A 100, node B 102, node C 104, node D 106, node E 108, node F 110, node G 112, node H 114, node J 116, node K 118, node M 120, node P 122, node Q 124, and node S 126. Each of these components is described below.

In one or more embodiments, each of the nodes (e.g., 100-126) shown in FIG. 1 are computing devices. In one or more embodiments, a computing device is any physical and/or logical device that manipulates, processes, stores, interacts with, and/or otherwise uses data of any type. In one or more embodiments, as used herein, a computing device may be any single computing device, a set of computing devices, a portion of one or more computing devices, or any other physical, virtual, and/or logical grouping of computing resources. In one or more embodiments, a computing device is any device, portion of a device, or any set of devices capable of electronically processing instructions and may include, but is not limited to, any of the following: one or more processors (e.g. components that include circuitry) (not shown), memory (e.g., random access memory (RAM)) (not shown), input and output device(s) (not shown), non-volatile storage hardware (e.g., solid-state drives (SSDs), hard disk drives (HDDs) (not shown)), one or more physical interfaces (e.g., network ports, storage ports) (not shown), any number of other hardware components (not shown), and/or any combination thereof.

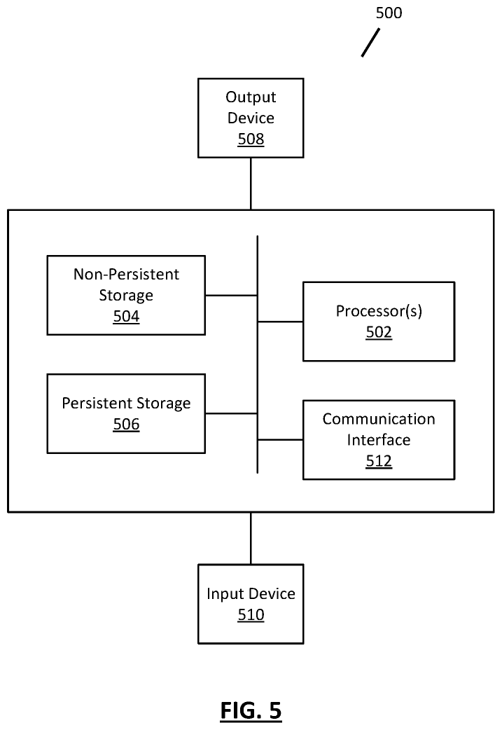

Examples of computing devices include, but are not limited to, a server (e.g., a blade-server in a blade-server chassis, a rack server in a rack, etc.), a desktop computer, a mobile device (e.g., laptop computer, smart phone, personal digital assistant, tablet computer, automobile computing system, and/or any other mobile computing device), a storage device (e.g., a disk drive array, a fibre channel storage device, an Internet Small Computer Systems Interface (iSCSI) storage device, a tape storage device, a flash storage array, a network attached storage device, etc.), a network device (e.g., switch, router, multi-layer switch, etc.), a virtual machine, a virtualized computing environment, a logical container (e.g., for one or more cloud applications), an Internet of Things (IoT) device, an array of nodes of computing resources, a supercomputing device, a data center or any portion thereof, a microservice, a container, a container pod, and/or any other type of computing device with at least some of the aforementioned requirements. In one or more embodiments, any or all of the aforementioned examples may be combined to create a system of such devices, or may be partitioned into separate logical devices, which may separately or collectively be referred to as a computing device. Other types of computing devices may be used without departing from the scope of embodiments described herein, such as, for example, the computing device shown in FIG. 5 and described below. The system may include any number and/or type of such computing devices in any arrangement and/or configuration without departing from the scope of embodiments disclosed herein.

In one or more embodiments, the storage (not shown) and/or memory (not shown) of a computing device or system of computing devices may be and/or include one or more data repositories for storing any number of data structures storing any amount of data (e.g., information) of any type. In one or more embodiments, a data repository is any type of storage unit and/or device (e.g., a file system, database, collection of tables, RAM, and/or any other storage mechanism or medium) for storing data. Further, the data repository may include multiple different storage units and/or devices. The multiple different storage units and/or devices may or may not be of the same type or located at the same physical location.

In one or more embodiments, any storage (not shown) and/or memory (not shown) of a computing device or system of computing devices may be considered, in whole or in part, as non-transitory computer readable mediums storing software and/or firmware.

Such software and/or firmware may include instructions which, when executed by the one or more processors (not shown) and/or other hardware (e.g. circuitry) of a computing device and/or system of computing devices, cause the one or more processors and/or other hardware components to perform operations in accordance with one or more embodiments described herein.

The software instructions may be in the form of computer readable program code to perform methods, processes, etc. of embodiments as described herein, and may, as an example, be stored, in whole or in part, temporarily or permanently, on a non-transitory computer readable medium such as a compact disc (CD), digital versatile disc (DVD), storage device, diskette, tape storage, flash storage, physical memory, or any other non-transitory computer readable medium.

Although FIG. 1 shows fourteen nodes (e.g., node A 100, node B 102, node C 104, node D 106, node E 108, node F 110, node G 112, node H 114, node J 116, node K 118, node M 120, node P 122, node Q 124, and node S 126), one having ordinary skill in the relevant art, and the benefit of this Detailed Description will appreciate that the system may include any number of nodes without departing from the scope of embodiments disclosed herein. All or any portion of the nodes may be the same type, or different types of computing devices. As an example, some of the nodes may be network devices, some nodes may be servers, some nodes may be storage devices, and some devices may be physical devices while other nodes are logical devices (e.g., virtual machines, containers, etc.).

In one or more embodiments, the nodes 100-126 operatively connected to one another and/or to any devices outside the mesh of nodes topology via a network. A network may refer to an entire network or any portion thereof (e.g., a logical portion of the devices within the mesh of nodes topology). The network may include a datacenter network, a wide area network, a local area network, a wireless network, a cellular phone network, an InfiniBand network, and/or any other suitable network that facilitates the exchange of information from one part of the network to another. The network may be a combination of any of the aforementioned network types. The network may be located at a single physical location or be distributed at any number of physical sites. In one or more embodiments, a network may be coupled with or overlap with, at least in part, the Internet.

In one or more embodiments, the mesh of nodes topology 130 is a representation of the nodes 100-126 that illustrates what nodes exist in the system, and how the nodes are interconnected. In one or more embodiments, the mesh of nodes topology includes a predetermined set of nodes (e.g., the nodes 100-126), each of which, as discussed above, is a computing device. In one or more embodiments, the mesh of nodes topology 130 is a representation of nodes in a topology (e.g., a network topology). A mesh of nodes may represent a physical topology, a logical topology, or a hybrid mesh that includes aspects of physical and logical topologies. Examples of topologies include, but are not limited to, point-to-point, star, bus, tree, ring, full or partial meshes, etc. Other examples include, but are not limited to, layer 2 (L2) network topologies, layer 3 (L3) network topologies, data flow topologies, etc. Any suitable one or more techniques for identifying nodes and connections between the nodes may be used to determine the mesh of nodes topology 130. Such techniques include, but are not limited to, network scanners, discovery protocols (e.g., link layer discovery protocol (LLDP)), application protocols (e.g., simple network management protocol (SNMP), web-services management (WS-MAN), etc.), manual configuration and/or discovery, etc. As shown in FIG. 1, the arrows between the nodes of the mesh of nodes topology 130 represent connections between the nodes, and, therefore, the mesh formed by the nodes and the connections.

In one or more embodiments, the mesh of nodes topology 130 is operatively connected to the drift detection device 132. In one or more embodiments, the drift detection device 132 is a computing device (discussed above). In one or more embodiments, the drift detection device 132 is configured to perform incident driven drift detection to determine whether drift is occurring in the mesh of nodes topology 130, or any portion thereof, to determine the severity of the drift, and to determine incidents that occur in the mesh of nodes topology 130 that may contribute to or otherwise cause the drift. In one or more embodiments, drift refers to a change in resource usage patterns of one or more nodes (e.g., the nodes 100-126) in the mesh of nodes topology 130. In one or more embodiments, an incident is any event that occurs on any one or more nodes (e.g., the nodes 100-126) of the mesh of nodes topology 130 that may cause drift to occur. Examples of incidents include, but are not limited to, expecte4d or unexpected device restarts, firmware/software changes, loss of redundancy, increased receipt of network traffic from outside the mesh or subgraph, power loss, system crashes, physical events (e.g., accidental unplugging of one or more network cables), etc.

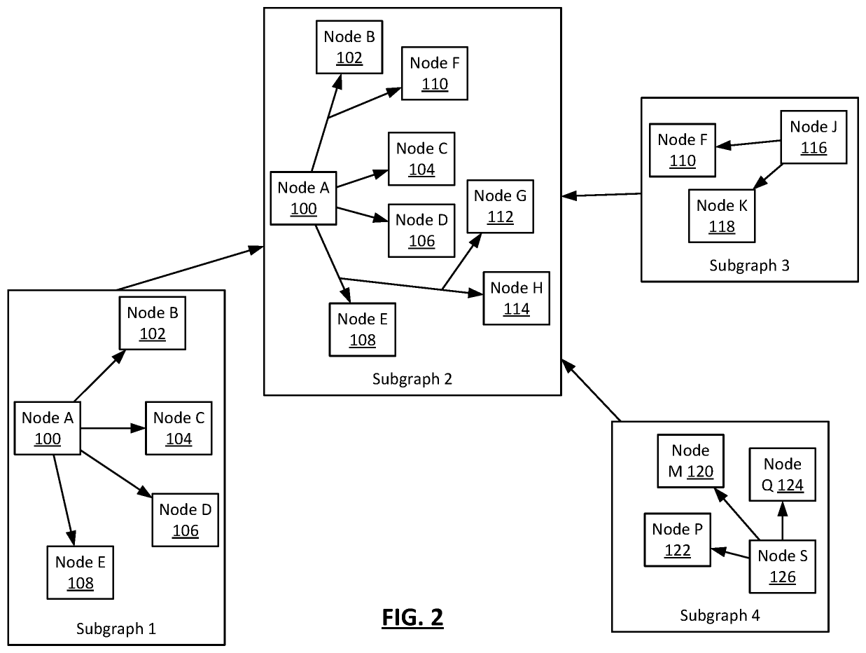

In one or more embodiments, the drift detection device 132 is operatively connected to the nodes of the mesh of nodes topology 130, and may receive information from and/or about the nodes, and the resource usage of the nodes (e.g., network bandwidth, processor usage, memory usage, executing threads, storage usage, etc.). The drift detection device 132 may also be configured to discover the mesh of nodes topology 130, and to represent the mesh of nodes topology 130 as any number of subgraphs (discussed further in the description of FIG. 2, below). In one or more embodiments, the drift detection device 132 is configured to receive information related to incidents that occur in the mesh of nodes topology 130, such as reboots, application restarts, loss of redundancy events, firmware and software updates, etc., and to correlate the incidents in time with resource usage patterns exhibited by all or any portion of the nodes in the mesh of nodes topology 130.

While FIG. 1 shows a particular configuration of components, other configurations may be used without departing from the scope of embodiments described herein. For example, although FIG. 1 shows the drift detection device as separate from and operatively connected to the mesh of nodes topology, the drift detection device may be a portion of any one or more nodes in the mesh of nodes topology. As another example, a single component may be configured to perform all, or any portion of the functionality performed by the all or any portion of the components shown in FIG. 1. Accordingly, embodiments disclosed herein should not be limited to the configuration of components shown in FIG. 1.

FIG. 2 illustrates a block diagram of the mesh of nodes topology 130 of FIG. 1, represented as a set of subgraphs: subgraph 1, subgraph 2, subgraph 3, and subgraph 4. In one or more embodiments, a subgraph is a portion of the nodes of the mesh of nodes topology 130 shown in FIG. 1. As shown in FIG. 2, subgraph 1 includes the node A 100, the node B 102, the node C 104, the node D 106, and the node E 108. Subgraph 2 includes the node A 100, the node B 102, the node C 104, the node D 106, the node E 108, the node F 110, the node G 112, and the node H 114. Subgraph 3 includes the node F 110, the node J 116, and the node K 118. Subgraph 4 includes the node M 120, the node P 122, the node Q 124, and the node S 126. In one or more embodiments, the nodes shown in FIG. 2 are the same or substantially similar to the nodes 100-126 shown in FIG. 1 and discussed above.

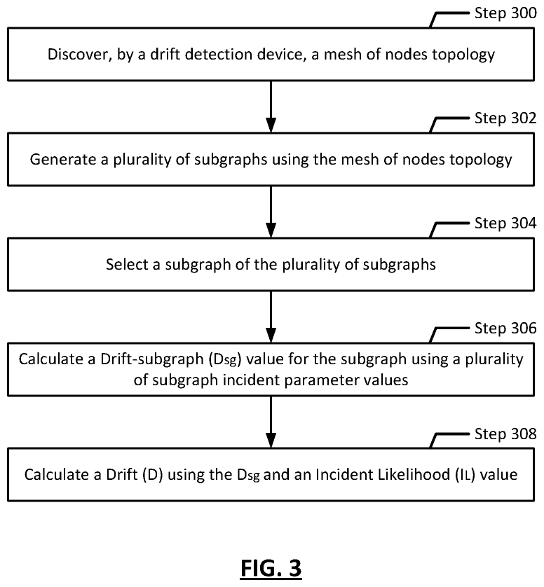

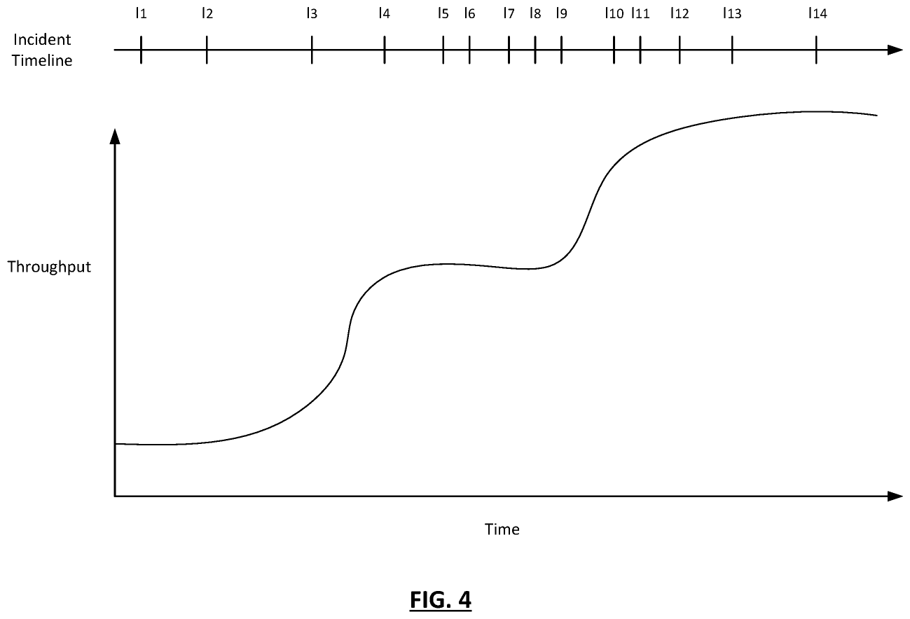

Given the potentially large quantity of nodes in modern data centers, embodiments disclosed herein may use node aggregation to form groups, or graphs, where each graph represents a collection of logical and/or physical elements within a mesh of nodes topology (e.g., the mesh of nodes topology 130 of FIG. 1). Such an approach allows for an organized representation of and management of a complex network of nodes that may be present, for example, in a data center environment. Such graphs may each be a sub-section of the mesh, and referred to herein as a subgraph. In one or more embodiments, representing a mesh of nodes by a number of subgraphs may allow for incidents causing drift in a mesh of nodes to be identified more quickly, as the subgraphs may be separately considered when performing drift calculations (discussed further below in the descriptions of FIG. 3 and FIG. 4).

In one or more embodiments, once the mesh of nodes topology 130 is discovered using one or any combination of the various techniques discussed above for discovering a mesh of nodes topology, a set of subgraphs may be generated, derived, obtained, etc. As an example, the drift detection device 132 shown in FIG. 1 may discover the mesh of nodes topology 130, and then generate the subgraphs 1-4 shown in FIG. 2 based on the mesh of nodes topology 130. In one or more embodiments, generating the subgraphs includes selecting a node as a non-leaf node, and performing a tree traversal within the mesh to a certain depth. Any depth may be chosen for a subgraph without departing from embodiments disclosed herein. As an example, a network device of the overall mesh may be selected as a non-leaf node at which to start a subgraph, and nodes connected to the network device may be considered leaf nodes that are at a depth of one, and nodes connected to those nodes may be at a depth of two relative to the network device, and so on. Any number of tree traversals starting with any number of selected non-leaf nodes and using any pre-selected depth(s) may be used to generate any number of subgraphs without departing from the scope of embodiments disclosed herein. Subgraphs may be non-overlapping (e.g., any given node is in only one subgraph), partially overlapping (e.g., some nodes may be in more than one subgraph), or a combination thereof (e.g., as shown in FIG. 2). The selection of how to choose nodes as non-leaf nodes, the depth of tree traversals, the number of subgraphs, etc. may depend on the size and/or complexity of the overall mesh, or any other relevant factor.

As shown in FIG. 2, subgraph 1 is generated using the node A 100 as a non-leaf node, and a tree traversal to a depth of one. Similar steps are taken for subgraph 3, using node J 116 as the non-leaf node, and subgraph 4, using the node S 126 as the non-leaf node. As an example, non-leaf nodes may be selected because they are network devices, such as routers or switches, to which other nodes are connected. Also, as shown in FIG. 2, subgraph 2 is generated using the node 100 as the non-leaf node, and performing a tree traversal to a depth of two. Thus, subgraph 1 includes a portion of the nodes that are also in subgraph 2. In one or more embodiments, once the subgraphs are generated, drift may be calculated for a particular subgraph, as discussed further below in the descriptions of FIG. 3 and FIG. 4.

While FIG. 2 shows a particular configuration of components, other configurations may be used without departing from the scope of embodiments described herein. For example, although FIG. 2 shows a certain set of subgraphs generated based on the mesh of nodes topology 130 of FIG. 1, any other organization of subgraphs including any of the nodes may be used when performing drift detection in accordance with one or more embodiments disclosed herein. Accordingly, embodiments disclosed herein should not be limited to the configuration of components shown in FIG. 2.

FIG. 3 illustrates an overview of an example method for performing incident driven drift detection in accordance with one or more embodiments disclosed herein. The method may be performed, at least in part, by a drift detection device (e.g., the drift detection device 132 shown in FIG. 1).

While the various steps in the flowchart shown in FIG. 3 are presented and described sequentially, some or all of the steps may be executed in different orders, some or all of the steps may be combined or omitted, and some or all of the steps may be executed in parallel with other steps of FIG. 3.

In Step 300, the method includes discovering, by a drift detection device (e.g., the drift detection device 132 shown in FIG. 1), a mesh of nodes topology (e.g., the mesh of nodes topology 130 shown in FIG. 1). The mesh of nodes topology may be discovered using any suitable technique for discovering the existence of any number of nodes, and the connections between the nodes. Such techniques include, but are not limited to, network scanners, discovery protocols (e.g., link layer discovery protocol (LLDP)), application protocols (e.g., simple network management protocol (SNMP), web-services management (WS-MAN), etc.), manual configuration and/or discovery, etc.

In Step 302, the method includes generating a plurality of subgraphs (e.g., the subgraphs 1-4 shown in FIG. 2) using the mesh of nodes topology discovered in Step 300. As an example, the plurality of subgraphs may be generated by a drift detection device (e.g., the drift detection device 132 of FIG. 1). In one or more embodiments, deriving a subgraph includes selecting a node, and performing a tree traversal within the mesh of nodes topology to a specified depth. Any depth may be chosen for a subgraph without departing from embodiments disclosed herein.

As an example, a network device of the mesh of nodes topology may be selected as a non-leaf node at which to start a subgraph, and devices connected to the network device may be considered leaf nodes that are at a depth of one, and devices connected to those devices may be at a depth of two relative to the network device, and so on. Any number of tree traversals starting with any number of selected non-leaf nodes and using any pre-selected depth(s) may be used to generate any number of subgraphs without departing from the scope of embodiments disclosed herein. Subgraphs may be non-overlapping (e.g., any given node is in only one subgraph), partially overlapping (e.g., some nodes may be in more than one subgraph), or a combination thereof. How to select nodes as non-leaf nodes, the depth of tree traversals, the number of subgraphs, etc. may depend on the size and/or complexity of the overall mesh, or any other relevant factor. As an example, a data center administrator may examine the nodes in the mesh of nodes topology, and decide to start with a portion of the network devices within the mesh of nodes topology as non-leaf nodes, and perform tree traversals to certain depths for each of the selected non-leaf nodes to generate a plurality of subgraphs.

In Step 304, the method includes selecting one or more subgraphs of the plurality of subgraphs generated in Step 302. In one or more embodiments, the one or more subgraphs are selected by a drift detection device (e.g., the drift detection device 132 of FIG. 1). In one or more embodiments, the selection of a subgraph may be based, at least in part, on information about resource usage (e.g., network bandwidth, processor usage, memory usage, executing threads, storage usage, etc.) on one or more nodes within the subgraph. As an example, a drift detection device may receive resource usage information from the nodes of the mesh of nodes topology, and generate a graph of resource usage over a selected time period (e.g., network bandwidth usage over a thirty minute time period). In one or more embodiments, if the resource usage experiences significant changes (either increases or decreases) within a relatively short period of time (e.g., over consecutive five minute intervals), then the drift detection device may select one or more subgraphs that include the one or more nodes for which the resource usage so changed in order to perform a drift calculation for the subgraph.

In Step 306, the method includes calculating a Drift-subgraph (D_{sg}) value for the subgraph selected in Step 304 using a plurality of subgraph incident parameter values. In one or more embodiments, subgraph incident parameter values include, but may not be limited to, Incident Quantity, Incident Fraction Potentially Causing Drift, Number of Nodes Capable of Causing Incident, Node Fraction Capable of Causing an Incident, and Incident Time. In one or more embodiments, the subgraph incident parameter values are obtained by a drift detection device (e.g., the drift detection device 132 shown in FIG. 1) as a part of calculating drift for a subgraph.

In one or more embodiments, D_{sg} is calculated by multiplying the subgraph incident parameter values, as shown in the following equation:

D_{sg}=(Incident Quantity)×(Incident Fraction Potentially Causing Drift)×(Number of Nodes Capable of Causing Incident)×(Node Fraction Capable of Causing an Incident)×(Incident Time).

In one or more embodiments, Incident Quantity is the total number of incidents that occur in a certain window of time for nodes in a selected subgraph. In one or more embodiments, the time window may be selected based on observing resource usage of any one or more types over time for nodes in a subgraph, and the Incident Quantity may be the number of incidents of any type that occur within the time window. As an example, a thirty minute window of time may be observed, and fourteen incidents may occur within the window, making the Incident Quantity value (14).

In one or more embodiments, Incident Fraction Potentially Causing Drift is a selection from the total number of incidents in the Incident Quantity of a subset of the incidents that are known to cause drift. As an example, a systems administrator or network administrator investigating drift in a mesh of nodes may examine the list of incidents that occurred in the time window (e.g., the incidents in the Incident Quantity), and use pre-existing knowledge of incidents to determine that only two of them are the type of incident that could potentially cause relevant drift, making the value for Incident Fraction Potentially Causing Drift ( 2/14).

In one or more embodiments, Number of Nodes Capable of Causing Incident is the number of nodes in a particular subgraph known to be capable of causing any of the incidents used in the Incident Fraction Potentially Causing Drift variable. As an example, an interested entity investigating drift in a mesh of nodes may be aware that only one node in a subgraph that includes five nodes may be a node that could cause the two incidents of the fourteen total incidents, making the value for Number of Nodes Capable of Causing Drift (1).

In one or more embodiments, the Node Fraction Capable of Causing an Incident is a fraction of the number of nodes that could cause an incident divided by the number of nodes in the subgraph. As an example, if a decision is made, as above, that one node in a mesh of five nodes may cause the two incidents known to potentially cause drift (e.g., the incidents used to find the Incident Fraction Potentially Causing Drift), the value for Node Fraction Capable of Causing an Incident is (⅕).

In one or more embodiments, the Incident Time is a length of time for a window in which an incident continues to exist. The Incident Time may be selected based on any relevant decision making parameter. In one or more embodiments, the Incident Time is selected based on domain knowledge or empirical knowledge, and represents a time below which the occurrence of an incident is not significant enough to cause relevant drift. As an example, the Incident time may be selected as thirty minutes, making the value for Incident Time (30).

In Step 308, the method includes calculating a drift (D) value using the D_{sg} value calculated in Step 306 and an Incident Likelihood (I_{L}) value. In one or more embodiments, the drift D is calculated by a drift detection device (e.g., the drift detection device 132 of FIG. 1). In one or more embodiments, the drift D is calculated using the following equation: D=D_{sg}×I_{L}. In one or more embodiments, D is the value for drift in a subgraph in a mesh of nodes, D_{sg} a value calculated for one or more drifts caused by one or more incidents in a given subgraph, and I_{L} is the likelihood that an incident causes drift.

I_{L} may be derived based on empirical knowledge of incident types. Thus, in one or more embodiments, different incident types may be assigned different values for I_{L} to represent the relative severity of drift due to that incident type. For example, a periodically performed task that happens every week but causes changes in resource usage in an expected manner may be assigned a low value for I_{L} (e.g., one), while a more severe event, such as a sudden and unexpected loss of network redundancy, may be assigned a higher value for I_{L} (e.g., 72). Any type of incident that may cause a change in resource usage in a mesh of nodes may be empirically assigned such a value, and the set of values may be stored in any form of data structure that can relate one type of information (e.g., a type of incident) to another type of information (e.g., an assigned value). As an example, there may be a table that includes a column for incident types and a corresponding column for assigned values of I_{L}. Expected and/or less severe events may be assigned lower I_{L} values, such as periodic performance of certain services, planned reboots of devices, planned software or firmware updates, application lifecycle events, etc. Unexpected and/or more severe events may be assigned higher I_{L} values, such as loss of redundancy, unexpected reboots, power loss events, firmware crashes, etc.

In one or more embodiments, performing the Steps 300-308 described above allow an entity investigating potential drift (e.g., a systems administrator, a network administrator, an engineer, etc.) occurring in a mesh of nodes to calculate a value for the drift that, if positive, confirms that drift is occurring, with the severity of the drift becoming more evident based on how high the positive value of the calculated drift is. The drift may be correlated to incidents occurring on nodes within a subgraph that are used to obtain the subgraph incident parameter values used to calculate the drift.

FIG. 4 illustrates an example representation of data that may be used to calculate drift, in accordance with one or more embodiments of this disclosure. The example shown in FIG. 4 and discussed below is a simplified example intended for explanatory purposes only, and not intended to limit the scope of embodiments described herein. Additionally, while the example shows certain aspects of embodiments described herein, all possible aspects of such embodiments may not be illustrated in this particular example.

Consider a scenario in which the node A 100 shown in subgraph 1 of FIG. 1 is a network device in a data center. Additionally, the node B 102, the node C 104, the node D 106, and the node E 108 are servers in a data center and are connected to the node A 100 network device. At a point in time, an engineer notices that the network throughput of the network device node A 100 has increased. Therefore, the engineer decides to investigate whether the increase in throughput constitutes drift, and what incidents may be causing the drift, by using a drift detection device (e.g., the drift detection device 132 shown in FIG. 1).

The drift detection device obtains resource usage information from the nodes of subgraph 1 shown in FIG. 2, and generates a graph of throughput over time for a thirty minute window in which the engineer suspects that drift may have occurred, which is shown in FIG. 4. The drift detection device also obtains a set of incidents that occurred on the nodes in the thirty minute window and generates a timeline of incidents that correspond to the same thirty minute window as is used for the graph shown in FIG. 4.

In this scenario, the engineer examines the graph and determines that there are two periods where throughput appears to have increased significantly enough to warrant performing a drift calculation. Therefore, the drift detection device obtains a count of incidents 11-114 on the incident timeline, which is fourteen, making the Incident Quantity subgraph incident parameter value of the D_{sg} equation (14).

The engineer then examines the incident timeline, and sees that, of the fourteen incidents occurred in the thirty minute window, based on the engineer's pre-existing knowledge of the types of incidents that may cause drift, only events I₃ and I₉ were possible causes of the drift seen on the throughput over time graph. The engineer conveys this number, two, to the drift detection device, which is then able to determine that making the value for Incident Fraction Potentially Causing Drift subgraph incident parameter value of the D_{sg} equation ( 2/14).

Next, the Number of Nodes Capable of Causing Incident subgraph incident parameter value of the D_{sg} equation is obtained by the engineer examining the subgraph 1 shown in FIG. 1, and determining, based on prior knowledge of how devices operate in regards to causing throughput increases, that there is only one node in subgraph 1, the network device node A 100, that is likely to be the cause of throughput increases, making the value for Number of Nodes Capable of Causing Drift (1). Moreover, as there are five nodes in the subgraph 1, the Node Fraction Capable of Causing an Incident subgraph incident parameter value of the D_{sg} equation is (⅕).

As previously mentioned, the time window being examined was arbitrarily selected by the engineer to be thirty minutes. Therefore, the Incident Time subgraph incident parameter value of the D_{sg} equation is (30).

Now that all of the subgraph incident parameter values of the D_{sg} equation have been obtained, the drift detection device may calculate D_{sg} as follows:

D_{sg}=(Incident Quantity)×(Incident Fraction Potentially Causing Drift)×(Number of Nodes Capable of Causing Incident)×(Node Fraction Capable of Causing an Incident)×(Incident Time)=(14)×( 2/14)×(1)×(⅕)×(30)=12

In one or more embodiments, once D_{sg} is obtained, the Drift, D, may be obtained by multiplying D_{sg} by I_{L}. Thus, I_{L} may be obtained from a table of I_{L} values corresponding to incidents, and multiplied by D_{sg}. Continuing the above example, a lookup may determine that I_{L} has a value of one, and, therefore, D=12×1=12. Thus, the drift value is twelve. In one or more embodiments, any value of D that is a positive number indicates that an incident occurred that caused drift, with higher values of D indicating more severe drift.

FIG. 5 illustrates a block diagram of a computing device, in accordance with one or more embodiments of this disclosure. As discussed above, embodiments described herein may be implemented using computing devices. For example, all or any portion of the components shown in FIG. 1 may be implemented, at least in part, using one or more computing devices. The computing device 500 may include one or more computer processors 502, non-persistent storage 504 (e.g., volatile memory, such as random access memory (RAM), cache memory, etc.), persistent storage 506 (e.g., a hard disk, an optical drive such as a compact disk (CD) drive or digital versatile disk (DVD) drive, a flash memory, etc.), a communication interface 512 (e.g., Bluetooth interface, infrared interface, network interface, optical interface, etc.), input devices 510, output devices 508, and numerous other elements (not shown) and functionalities. Each of these components is described below.

In one or more embodiments, the computer processor(s) 502 may be an integrated circuit for processing instructions. For example, the computer processor(s) may be one or more cores or micro-cores of a processor. The processor 502 may be a general-purpose processor configured to execute program code included in software executing on the computing device 500. The processor 502 may be a special purpose processor where certain instructions are incorporated into the processor design. Although only one processor 502 is shown in FIG. 5, the computing device 500 may include any number of processors without departing from the scope of embodiments disclosed herein.

The computing device 500 may also include one or more input devices 510, such as a touchscreen, keyboard, mouse, microphone, touchpad, electronic pen, motion sensor, or any other type of input device. The input devices 510 may allow a user to interact with the computing device 500. In one or more embodiments, the computing device 500 may include one or more output devices 508, such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) 502, non-persistent storage 504, and persistent storage 506. Many different types of computing devices exist, and the aforementioned input and output device(s) may take other forms. In some instances, multimodal systems can allow a user to provide multiple types of input/output to communicate with the computing device 500.

Further, the communication interface 512 may facilitate connecting the computing device 500 to a network (not shown) (e.g., a local area network (LAN), a wide area network (WAN) such as the Internet, mobile network, or any other type of network) and/or to another device, such as another computing device. The communication interface 512 may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 WiFi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 512 may also include one or more Global Navigation Satellite System (GNSS) receivers or transceivers that are used to determine a location of the computing device 500 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

The term computer-readable medium includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory, or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

All or any portion of the components of the computing device 500 may be implemented in circuitry. For example, the components can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

In the above description, numerous details are set forth as examples of embodiments described herein. It will be understood by those skilled in the art (who also have the benefit of this Detailed Description) that one or more embodiments described herein may be practiced without these specific details, and that numerous variations or modifications may be possible without departing from the scope of the embodiments described herein. Certain details known to those of ordinary skill in the art may be omitted to avoid obscuring the description.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including functional blocks that may include devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but may have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

In the above description of the figures, any component described with regard to a figure, in various embodiments described herein, may be equivalent to one or more same or similarly named and/or numbered components described with regard to any other figure. For brevity, descriptions of these components may not be repeated with regard to each figure. Thus, each and every embodiment of the components of each figure is incorporated by reference and assumed to be optionally present within every other figure having one or more same or similarly named and/or numbered components. Additionally, in accordance with various embodiments described herein, any description of the components of a figure is to be interpreted as an optional embodiment, which may be implemented in addition to, in conjunction with, or in place of the embodiments described with regard to a corresponding one or more same or similarly named and/or numbered component in any other figure.

Throughout the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

While embodiments discussed herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. An apparatus, comprising:
one or more processors; and
one or more non-transitory computer readable media storing instructions which, when executed by the one or more processors, cause the one or more processors to:
discover, by a drift detection device executing on the one or more processors, a mesh of nodes topology;
generate a plurality of subgraphs using the mesh of nodes topology, wherein each of the plurality of subgraphs comprises a portion of a plurality of nodes of the mesh of nodes;
select a subgraph of the plurality of subgraphs;
calculate a Drift-subgraph (D_{sg}) value for the subgraph using a plurality of subgraph incident parameter values; and
calculate a drift value (D) using the D_{sg} value and an Incident likelihood (I_{L}) value, wherein the drift value indicates whether drift occurred in the subgraph.

2. The apparatus of claim 1, wherein, to generate the plurality of subgraphs using the mesh of nodes topology, the instructions further cause the one or more processors to:
select a non-leaf node from the mesh of nodes topology; and
perform a tree traversal starting at the non-leaf node and using a selected depth.

3. The apparatus of claim 1, wherein the plurality of subgraph incident parameter values comprise an Incident Quantity value, an Incident Fraction Potentially Causing Drift value, a Number of Nodes Capable of Causing Drift value, a Node Fraction Capable of Causing an Incident value, and an Incident Time value.

4. The apparatus of claim 3, wherein an equation used to calculate the D_{sg} value is: D_{sg}=(Incident Quantity)×(Incident Fraction Potentially Causing Drift)×(Number of Nodes Capable of Causing Drift)×(Node Fraction Capable of Causing an Incident)×(Incident Time).

5. The apparatus of claim 1, wherein D is calculated by multiplying the D_{sg} value and the I_{L} value.

6. The apparatus of claim 1, wherein a positive value of D indicates that drift occurred.

7. The apparatus of claim 6, wherein a magnitude of the positive value of D indicates a severity of the drift.

8. A computer-implemented method, comprising:
discovering, by a drift detection device executing on one or more processors, a mesh of nodes topology;
generating a plurality of subgraphs using the mesh of nodes topology, wherein each of the plurality of subgraphs comprises a portion of a plurality of nodes of the mesh of nodes;
selecting a subgraph of the plurality of subgraphs;
calculating a Drift-subgraph (D_{sg}) value for the subgraph using a plurality of subgraph incident parameter values; and
calculating a drift value (D) using the D_{sg} value and an Incident likelihood (I_{L}) value, wherein the drift value indicates whether drift occurred in the subgraph.

9. The method of claim 8, wherein, generating the plurality of subgraphs using the mesh of nodes topology comprises:
selecting a non-leaf node from the mesh of nodes topology; and
performing a tree traversal starting at the non-leaf node and using a selected depth.

10. The method of claim 8, wherein the plurality of subgraph incident parameter values comprise an Incident Quantity value, an Incident Fraction Potentially Causing Drift value, a Number of Nodes Capable of Causing Drift value, a Node Fraction Capable of Causing an Incident value, and an Incident Time value.

11. The method of claim 10, wherein an equation used to calculate the D_{sg} value is: D_{sg}=(Incident Quantity)×(Incident Fraction Potentially Causing Drift)×(Number of Nodes Capable of Causing Drift)×(Node Fraction Capable of Causing an Incident)×(Incident Time).

12. The method of claim 8, wherein D is calculated by multiplying the D_{sg} value and the I_{L} value.

13. The method of claim 8, wherein a positive value of D indicates that drift occurred.

14. The method of claim 13, wherein a magnitude of the positive value of D indicates a severity of the drift.

15. A non-transitory computer-readable medium storing programming for execution by one or more processors, the programming comprising instructions to:
one or more processors; and
one or more non-transitory computer readable media storing instructions which, when executed by the one or more processors, cause the one or more processors to:
discover, by a drift detection device executing on the one or more processors, a mesh of nodes topology;
generate a plurality of subgraphs using the mesh of nodes topology, wherein each of the plurality of subgraphs comprises a portion of a plurality of nodes of the mesh of nodes;
select a subgraph of the plurality of subgraphs;
calculate a Drift-subgraph (D_{sg}) value for the subgraph using a plurality of subgraph incident parameter values; and
calculate a drift value (D) using the D_{sg} value and an Incident likelihood (I_{L}) value, wherein the drift value indicates whether drift occurred in the subgraph.

16. The non-transitory computer-readable medium of claim 15, wherein, to generate the plurality of subgraphs using the mesh of nodes topology, the non-transitory computer-readable medium comprises further instructions to:
select a non-leaf node from the mesh of nodes topology; and
perform a tree traversal starting at the non-leaf node and using a selected depth.

17. The non-transitory computer-readable medium of claim 15, wherein the plurality of subgraph incident parameter values comprise an Incident Quantity value, an Incident Fraction Potentially Causing Drift value, a Number of Nodes Capable of Causing Drift value, a Node Fraction Capable of Causing an Incident value, and an Incident Time value.

18. The non-transitory computer-readable medium of claim 17, wherein an equation used to calculate the D_{sg} value is: D_{sg}=(Incident Quantity)×(Incident Fraction Potentially Causing Drift)×(Number of Nodes Capable of Causing Drift)×(Node Fraction Capable of Causing an Incident)×(Incident Time).

19. The non-transitory computer-readable medium of claim 15, wherein D is calculated by multiplying the D_{sg} value and the I_{L} value.

20. The non-transitory computer-readable medium of claim 15, wherein a positive value of D indicates that drift occurred, and a magnitude of the positive value of D indicates a severity of the drift.
